(19) United States
(12) Patent Application Publication
(10) Pub. No.: US 2009/0046195 A1
(43) Pub. Date: Feb. 19, 2009

(54) VARIBLE FOCUS LENS

(75) Inventors: Bernardus Hendrikus Wilhelmus Hendriks, Eindhoven (NL); Stein Kuiper, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/569,758

(22) PCT Filed: May 27, 2005
(86) PCT No.: PCT/IB2005/051743

§ 371 Date: Oct. 6, 2008

(30) Foreign Application Priority Data
Jun. 1, 2004 (EP) 04102437.3

(51) Int. Cl. H04N 5/232

(52) U.S. Cl. 348/345; 348/E05.042

(57) ABSTRACT

A variable focus (10) lens comprising a fluid chamber (12) containing a first fluid (14) and a second fluid (16) is disclosed. The fluids are non-miscible and in contact over a meniscus (18) and the second fluid is able to alter its shape on the influence of a magnetic field. The second fluid is preferably a ferrofluid. Means (20, 22) for applying a gradient magnetic field (24) over at least a part of the fluid chamber are provided that are capable of inducing a magnetic flux maximizing movement of the fluids, such that the shape of the meniscus varies in dependence on the magnetic field.

### FIELD OF THE INVENTION

The present invention relates to a variable focus lens comprising a first fluid and a second fluid, the fluids being non-miscible and in contact over a meniscus. By changing the shape of the meniscus, the focus of the lens can be varied.

### BACKGROUND OF THE INVENTION

Prior art variable focus lenses are known as electrowetting lenses. These electrowetting lenses comprise a fluid chamber containing two non-miscible fluids that form a meniscus at the interface between these fluids. Thus, provided that the fluids have different indices of refraction, the system can act as a refractive lens. Since one of the fluids is electrically conductive while the other fluid is not, by applying an electrical field to the lens, the shape of the meniscus and thereby the focus of the lens can be varied.

Electrowetting lenses are for example described in WO 03/069380 A1.

Due to the low power consumption and the quick response to a varying voltage, electrowetting lenses are particularly suitable for mobile applications in which a frequent focus variation is desired. Further, the simple construction in combination with the fact that the lens contains no mechanical parts is particularly advantageous.

However, a drawback of electrowetting lenses is the relative large switching voltage that is needed to obtain a sufficient variation in the shape of the meniscus. Typical switching voltages are in the range of 100 V. There is further a maximum change in the meniscus radius due to the limited breakdown voltage of the required insulating layer between the electrode and the conducting liquid, or due to saturation effects.

An object of the present invention is to provide a variable focus lens for which the required switching voltages are reduced and for which no limit of the focus change due to a breakdown voltage exists.

### SUMMARY OF THE INVENTION

The above objects are solved by the features of the independent claims. Further developments and preferred embodiments of the invention are outlined in the dependent claims.

In accordance with the present invention, there is provided a variable focus lens comprising a fluid chamber containing a first fluid and a second fluid, the fluids being non-miscible and in contact over a meniscus and the second fluid being able to alter its shape on the influence of a magnetic field, and means for applying a gradient magnetic field over at least a part of the fluid chamber, thereby inducing a magnetic flux maximizing movement of the fluids, such that the shape of the meniscus varies in dependence on the magnetic field. Thus, by applying a magnetic field, the focus of the lens can be altered due to the induced meniscus change. In principle, all fluids having a sufficient magnetic moment can be employed with the present invention.

Preferably, the second fluid is a ferrofluid. In a gradient magnetic field a ferrofluid responds as a homogeneous magnetic liquid which moves to the region of highest flux. Ferrofluids are generally provided by using a multi-phase liquid in which ferri- or ferromagnetic particles are held in a colloidal suspension in a carrier liquid.

The present invention is particularly advantageous with relation to an embodiment, wherein the fluid chamber comprising a substantially cylindrical wall, and the means for applying a gradient magnetic field comprising at least one coil to which a voltage can be applied in order to generate the gradient magnetic field. Thus, the magnetic field can easily be generated and varied by a variable voltage.

According to a preferred embodiment of the present invention the gradient magnetic field is substantially localized to a vertex region of the meniscus. It is sufficient to produce a magnetic field gradient near the vertex in order to alter the whole shape of the meniscus. Therefore, it is useful to substantially localize the magnetic field to this region, thereby reducing the total magnetic field strength required.

Advantageously, the first fluid and the ferrofluid are transparent, the fluids having different indices of refraction. Thereby, a refractive lens is provided.

According to a further embodiment the first fluid is transparent and the ferrofluid is non-transparent. In this case a reflective lens is provided. This reflective lens is operated by coupling light from an object into the optical path between the lens and the image.

In this context it is particularly advantageous that a metal liquid like film is trapped at at least part of the interface between the two liquids in order to form a mirror surface. Such metal liquid like films (MELLF) consist of small particles that are trapped at the interface between the two liquids forming a mirror surface. Thereby the reflective properties of the reflective lens are improved.

According to a still further embodiment a magnetic field is applied in order to shift particles that are responsible for the non-transparency of the ferrofluid into the direction of the vertex region of the meniscus, thereby generating a transparent region in the second fluid, the first fluid and the transparent region of the second fluid having different indices of refraction. By this measure, even with a non-transparent ferrofluid the operation of the variable focus lens according to the invention as a refractive lens is possible.

In a further embodiment the first fluid and the second fluid have substantially the same density. As a consequence, gravity has no effect on the meniscus.

Preferably, one of the fluids is hydrophilic and one of the fluids is lipophilic. Since water-based ferrofluids as well as oil-based ferrofluids are known, several combinations of first and second fluids are possible.

The variable focus lens can be advantageously implemented in an optical device and more particularly in an image capture device. For example, mobile telephones that are provided with an image capturing feature can be provided with a variable focus lens according to the present invention in order to maintain the small size of these devices. However, also different image capturing devices, such as normal cameras or video cameras can be provided with an optical device according to the present invention, since also in case of these devices it is desirable to avoid mechanical moving parts, to reduce the devices in size, to provide the possibility of a quick and considerable focus change, and to obtain this focus change on a low voltage level.

Other application areas are located in optical recording, ophthalmic lenses, endoscopy lenses, telescopes, microscopy and lithography.

These and other aspects of the invention will be apparent from and elucidated with reference to the embodiments described hereinafter.

### BRIEF DESCRIPTION OF THE DRAWINGS

FIG. 1 shows a variable focus lens in accordance with an embodiment of the present invention in schematic cross section in a first switching configuration;

FIG. 2 shows the variable focus lens of FIG. 1 in a second switching configuration;

FIG. 3 shows a further embodiment of a variable focus lens in accordance with an embodiment of the present invention in schematic cross section;

FIG. 4 shows an image capture device comprising a lens 10 according to the present invention; and

FIG. 5 shows elements from an optical scanning device containing a lens in accordance with an embodiment of the invention.

### DESCRIPTION OF PREFERRED EMBODIMENTS

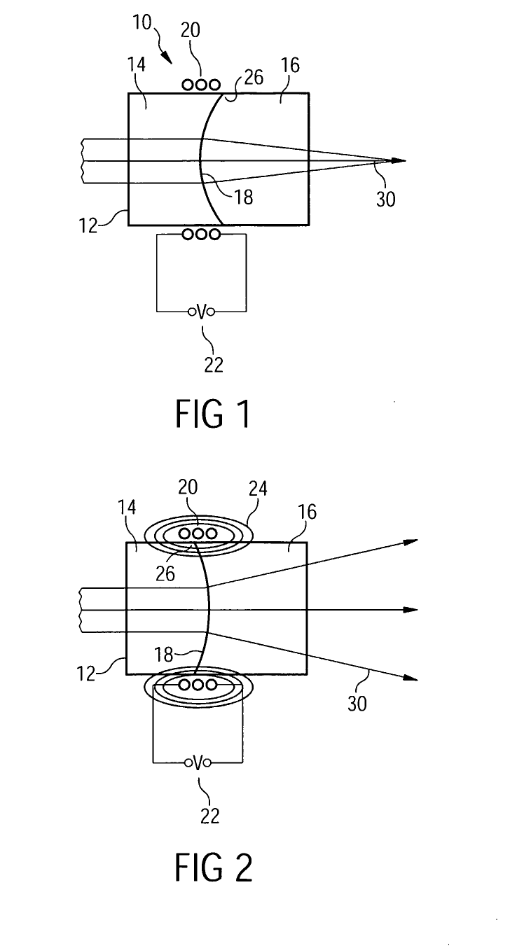

FIG. 1 shows a variable focus lens in accordance with an embodiment of the present invention in schematic cross section in a first switching configuration. The cross section shows an axial cut through the lens 10. The lens 10 comprises a cylindrical fluid chamber 12. In the fluid chamber 12 a first fluid 14 and a second fluid 16 are provided, the second fluid being a ferrofluid. The fluids are non-miscible. Thus, at the interface between the fluids 14, 16, a meniscus 18 is formed. The inner wall of the fluid chamber 12 may be coated with a fluid contact layer (not shown), which reduces the hysteresis in the contact angle of the meniscus with the cylindrical wall of the fluid chamber 12. The fluid contact layer is preferably formed from an amorphous fluorocarbon such as Teflon™ AF1600 produced by Dupont™. The fluid contact layer has a preferred thickness of between 5 nm and 50 μm. The AF1600 coating may be produced by successive dip coating of the fluid chamber 12, which forms a homogeneous layer of material of substantially uniform thickness; dip coating is performed by dipping the fluid chamber 12 whilst moving it in and out of the dipping solution along its axial direction. Another preferred fluid contact layer is formed by a fluorosilane, preferably applied in a monolayer by vapour deposition or deposition from a solution. Preferably, the two fluids 14, 16 have similar densities so that the shape of the meniscus 18 does not depend on the orientation of the lens. In a vertex region 26 of the meniscus 18, a coil 20 having a power supply 22 for generating a gradient magnetic field is arranged outside the fluid chamber 12. Other means for generating a variable gradient magnetic field are also applicable, for example a movable permanent magnet. The operation of the variable focus lens 10 will be described with further reference to FIG. 2 as described below.

There are numerous possibilities for selecting appropriate combinations of the fluids 14 and 16. For example, the fluid 14 can be water-based. In this case, the second fluid 16 is a lipophilic ferrofluid. It is also possible to provide a hydrophilic ferrofluid 16. In this case, the first fluid 14 is lipophilic. Both of the fluids can be influenced with respect to the physical properties, particularly with respect to their density and their refractive indices by dissolving further substances in the fluids. For example, a water-based solution may be altered with respect to the mentioned properties by adding salt. The lipophilic fluid, for example an alkane or silicone oil, may be modified by addition of molecular constituents. In order to operate the variable focus lens 10 as a refractive lens, both of the fluids 14 and 16 have to be at least partly transparent comprising different indices of refraction. The transparency of the ferrofluid 16 can be achieved by either providing a transparent ferrofluid or by providing a transparent central region in the ferrofluid 16. The latter can be achieved by shifting the magnetic particles in the fluid into the direction of the walls of the fluid chamber 12.

FIG. 2 shows the variable focus lens of FIG. 1 in a second switching configuration. The same variable focus lens 10 as in FIG. 1 is depicted. In contrast to FIG. 1, a current flows through the coil 20 thereby generating a gradient magnetic field 24 in the vertex region 26 of the meniscus 18. As a consequence, the system tends to maximize the magnetic flux which can be achieved by shifting the ferrofluid 16, so as to get into the regions with high magnetic field strength. The meniscus as a whole adapts its shape in accordance with the variations in the vertex region 26. Particularly, a magnetic field gradient in the vertex region 26 is sufficient to alter the shape of the meniscus 18. Hence, even if a non-transparent ferrofluid 16 is provided, the magnetic particles that induce non-transparency to the fluid can be shifted to the wall region of the fluid chamber, thereby providing transparency in a central region of the fluid chamber 12 and still providing the possibility to alter the shape of the meniscus by applying a gradient magnetic field 24 in the vertex region 26.

As a consequence, with respect to the light beams 30 indicated in FIG. 1 and FIG. 2, the variable focus lens 10 has a focusing characteristic in FIG. 1 and a defocusing characteristic in FIG. 2. By appropriate selection of the magnetic field strength and the magnetic field geometry, different shapes of the meniscus 18 can be achieved, particularly such shapes that lie in between the extreme switching configurations as shown in FIG. 1 and FIG. 2.

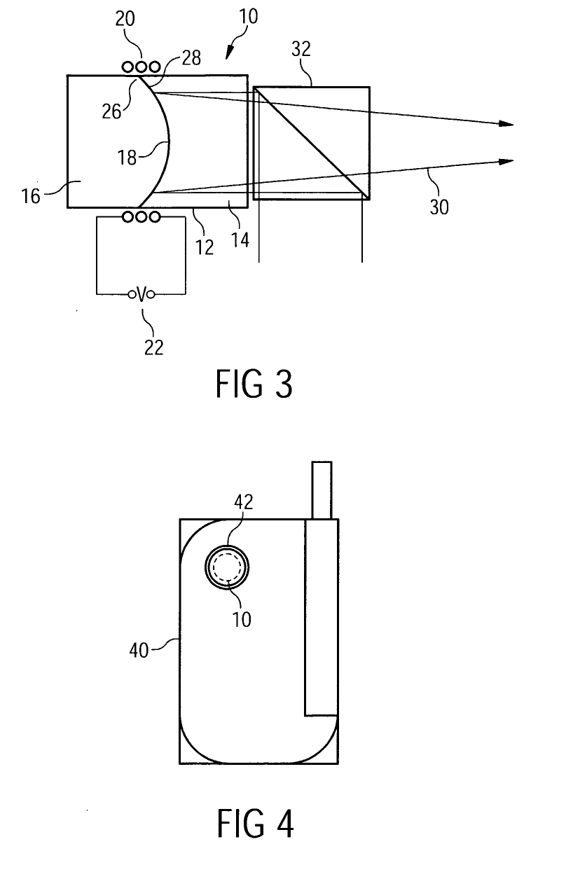

FIG. 3 shows a further embodiment of a variable focus lens in accordance with an embodiment of the present invention in schematic cross section. The fluid chamber and its constituents and periphery is built up similarly as the fluid chamber according to FIGS. 1 and 2. In contrast to the embodiment according to FIG. 1 and FIG. 2, the ferrofluid 16 is non-transparent and no measures have been taken in order to provide a region of transparency. Thus, the variable focus lens 10 according to FIG. 3 can not be operated as a refractive lens but as a reflective lens. In order to provide an improved reflectivity at the interface between the fluids 14 and 16, a metal liquid like film (MELLF) is provided at this interface. MELLFs consist of small particles that are trapped at the interface between the two liquids forming a mirror surface. For example, the fabrication of MELLFs involves the creation of silver nanoparticles, generally by chemical reduction of a silver salt in aqueous solution, and the subsequent coating of the particles with a strong metal-bonding organic molecule, a ligand. When coated, the particles are no longer stable in the aqueous phase and spontaneously assemble on the water-organic interface. Again, the focus change can be achieved by applying a magnetic field near the vertex region 26, thereby altering the shape of the meniscus 18. Outside the variable focus lens 10, appropriate means are arranged in order to provide an optical path between object and image. A plurality of optical devices, such as lenses, collimators, etc. can be provided. As an example a beam splitter 32 is shown.

FIG. 4 shows an image capture device comprising a lens 10 according to the present invention. In the present example, the image capture device is a mobile telephone 40 having a picture capturing capability. The mobile telephone 40 comprises a lens system 42 into which a variable focus lens according to the present invention is included.

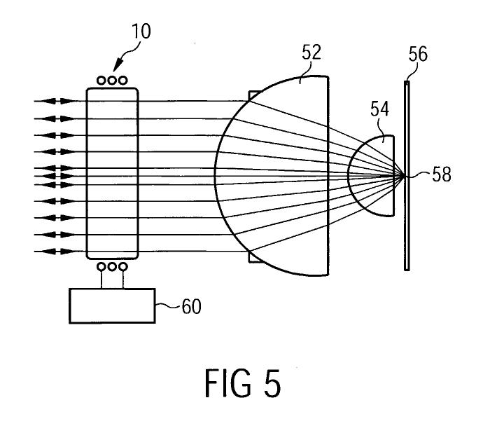

FIG. 5 shows elements from an optical scanning device containing a lens in accordance with an embodiment of the invention. The device is for recording and/or playback from an optical disk 56, for example a dual layer digital video recording (DVR) disk (see for instance the article by K. Schep, B. Stek, R. van Woudenberg, M. Blum, S. Kobayashi, T. Narahara, T. Yamagami, H. Ogawa, “Format description and evaluation of the 22.5 GB DVR disc”, Technical Digest, ISOM 2000, Chitose, Japan, Sep. 5-8, 2000). The device includes a compound objective lens, for instance having a numerical aperture of 0.85, including a rigid front lens 52 and a rigid rear lens 54, for instance as described in International patent application WO 01/73775, for focusing the incoming collimated beam, for instance having a wavelength of 405 nm, consisting of substantially parallel rays, to a spot 58 in the plane of an information layer currently being scanned.

In dual layer DVR disks the two information layers are at depths of 0.1 mm and 0.08 mm; they are thus separated by typically 0.02 mm. When refocusing from one layer to the other, due to the difference in information layer depth, some 200 mλ of unwanted spherical wavefront aberration arises, which needs to be compensated. One way to achieve this is to change the vergence of the incoming beam using a mechanical actuator, for example moving a collimator lens in the device, which is relatively expensive. Another approach is to use a switchable liquid crystal cell, which is also a relatively expensive solution.

In this embodiment, a switchable variable focus lens 10 similar to that described in relation to FIGS. 1 and 2 is used. Each of the fluids, when the lens 10 is arranged with a planar meniscus, has a thickness of approximately 1 mm.

The device includes an electronic control circuit 60 for applying one of two selected voltages to the coil of the lens 10 in dependence on the information layer currently being scanned. In one configuration, during the scanning of the information layer depth of 0.08 mm, a relatively low selected voltage is applied to produce a meniscus curvature of radius R=−21.26 mm. In the other configuration, during the scanning of the information layer depth of 0.1 mm, a relatively high selected voltage is applied to produce a planar meniscus curvature. As a result, the root mean square value of the wavefront aberration can be reduced from 200 mλ to 18 mλ. Note that a similar effect can be obtained using different combinations of meniscus curvatures, since only a variation in lens power is required; furthermore the difference in lens power can also be achieved with larger movements in the meniscus by making the refractive indices of the two liquids more similar. It is noted that the variable focus lens according to the present invention can be different from the example shown in the drawing and described above. Although it is preferable that the lens is cylindrical, deviations from a cylindrical shape are possible such as conical or any other shape. Further, it is within the scope of the present invention that the magnetic field is not only applied by a single coil but by a plurality of coils in order to design the magnetic field gradient and finally the meniscus to a particular shape. Generally, it is to be noted that the term “comprising” in the present disclosure does not exclude further elements and that also the mentioning of a particular element does not exclude that a plurality of elements related to the mentioned element are present. The above embodiments are to be understood as illustrative examples of the invention. Further embodiments of the invention are envisaged. For example, the first fluid may consist of a vapor rather than a liquid.

Furthermore, equivalents and modifications not described above may also be employed without departing from the scope of the invention, which is defined in the accompanying claims.

1. A variable focus (10) lens comprising:
a fluid chamber (12) containing a first fluid (14) and a second fluid (16), the fluids being non-miscible and in contact over a meniscus (18) and the second fluid being able to alter its shape on the influence of a magnetic field, and
means (20, 22) for applying a gradient magnetic field (24) over at least a part of the fluid chamber, thereby inducing a magnetic flux maximizing movement of the fluids, such that the shape of the meniscus varies in dependence on the magnetic field.

2. The variable focus lens according to claim 1, wherein the second fluid (16) is a ferrofluid.

3. The variable focus lens according to claim 1, wherein the fluid chamber comprising a substantially cylindrical wall.

4. The variable focus lens according to claim 1, wherein the means for applying a gradient magnetic filed comprising at least one coil (20) to which a voltage (22) can be applied in order to generate the gradient magnetic field.

5. The variable focus lens according to claim 1, wherein the gradient magnetic field is substantially localized to a vertex region (26) of the meniscus.

6. The variable focus lens according to claim 1, wherein the first fluid and the ferrofluid are transparent, the fluids having different indices of refraction.

7. The variable focus lens according to claim 1, wherein the first fluid is transparent and the ferrofluid is non-transparent.

8. The variable focus lens according to claim 7, wherein a metal liquid like film (28) is trapped at at least part of the interface between the two liquids in order to form a mirror surface.

9. The variable focus lens according to claim 7, wherein a magnetic field is applied in order to shift particles that are responsible for the non-transparency of the ferrofluid into the direction of the vertex region (26) of the meniscus (18), thereby generating a transparent region in the second fluid, the first fluid and the transparent region of the second fluid having different indices of refraction.

10. The variable focus lens according to claim 1, wherein the first fluid (14) and the second fluid (16) have substantially the same density.

11. The variable focus lens according to claim 1, wherein one of the fluids (14, 16) is hydrophilic and one of the fluids (14, 16) is lipophilic.

12. An optical device comprising a lens (10) according to claim 1.

13. An image capture device (40) comprising a lens (10) according to claim 1.

14. An optical recording device comprising a lens (10) according to claim 1.
